(19) United States
(12) Patent Application Publication
(10) Pub. No.: US 2007/0157226 A1
(43) Pub. Date: Jul. 5, 2007

(54) Segmentation and communication of live-action sporting event data apparatus and method

(76) Inventor: Raghavendra Misra, Jacksonville Beach, FL (US)

Correspondence Address: Raj Abhyanker, LLP;C/O PortfolioIP, P.O. Box 52050, Minneapolis, MN, 55402, US

(21) Appl. No.: 11/314,251

(22) Filed: Dec. 21, 2005

(51) Int. Cl. H04N 7/173; H04N 7/16

(52) U.S. Cl. 725/25; 725/135; 725/136; 725/114; 725/115

(57) ABSTRACT

Segmentation and communication of live-action sporting event data apparatus and method is disclosed. In one embodiment, a method includes generating a meta data based on an analysis of a live-action sport data with an event control data, segmenting the live-action sport data based on an identifier code referenced by an event module generating the live-action sport data, and providing access to the live-action sport data and the meta data based on an affiliation with a subscription-based location network. The event control data may include a parametric model of an ideal state of a particular form of a participant and/or a trajectory of a projectile utilized in a live-action sporting event associated with the live-action sport data. The meta-data can include an event statistic and/or an historical statistic of the participant in the live-action sporting event.

### FIELD OF TECHNOLOGY

This disclosure relates generally to the technical fields of software and/or hardware technology and, in one example embodiment, to segmentation and communication of live-action sporting event data apparatus and method.

### BACKGROUND

A participant (e.g., a player of a sport) in a live-action sporting event (e.g., any event in which individuals and/or teams physically and/or mentally compete, such baseball, cricket, soccer, football, poker, chess, bowling, tennis, basketball, badminton, swimming, etc.) can improve his/her skills (e.g., techniques, talents, aptitude, etc.) by studying and/or analyzing performance in previous live action events. For example, the participant may wish to analyze a form of their stance when pitching a baseball and/or a trajectory (e.g., thrown, hit, repositioned) of a projectile (e.g., the baseball) used during play in a previous season. Similarly, the participant may wish to analyze techniques of star players and/or competing teams.

Expensive hardware and/or software technologies can used to study and/or analyze animations of previous live action events. Particularly, a team and/or a league may invest hundreds of thousands of dollars in high-end cameras, hardware, and/or expensive software (e.g., such as that marketed by Hawkeye® Innovations). These technologies may create animated models of play rather than provide motion-video modeling. Furthermore, these technologies may not be easily portable from one stadium and/or sports facility to another. As such, technologies to study and/or analyze animations of previous live action events may be available only to professional players (e.g., Major League Baseball® players), rather than amateur players and/or children in local leagues who may benefit from such technologies the most (e.g., to improve their performance and/or skills so that they may have a better chance of becoming compensated professional players).

Sharing of data captured from technologies to study and/or analyze animations of previous live-action events may be geographically limited to an area (e.g., a city) where the live action event took place. The participant (e.g., who took part in the live-action sporting event in which the performance was animated) may need to go to a special facility to view and/or study their performance. In addition, sharing of the participant's footage with coaches, players, scouts, etc. (e.g., collectively ‘others’) may be difficult without manual authorization by the participant at the special facility. The others may have to travel to the special facility to gain access, review, and/or analyze footage after being granted permission by the participant. An administrator may have to review a log book to ensure that the participant has provided the others with access privileges and/or permission for access. This can be a time consuming, confusing, and/or expensive process.

### SUMMARY

Segmentation and communication of live-action sporting event data apparatus and method is disclosed. In one aspect, a method includes generating a meta data based on an analysis of a live-action sport data with an event control data, segmenting the live-action port data based on an identifier code referenced by an event module generating the live-action sport data, and providing access to the live-action sport data and the meta data based on an affiliation with a subscription-based location network.

The method may also include permitting a default coach of a team to access the live-action sport data associated with each participant in the team, enabling each participant to change an access privilege of the default coach (e.g., to allocate a permission to other members of the team, a sponsor, a scout, a virtual coach, a governing body (e.g., school and/or university athletic department), a biomechanics expert, a celebrity, a statistician, and/or a guardian). The method may further include enabling the guardian to subscribe to the subscription-based location network and/or to determine access privileges of a participant in the care of the guardian. The event control data may include a parametric model of an ideal state of a particular form of a participant and/or a trajectory of a projectile utilized in a live-action sporting event associated with the live-action sport data. The meta-data can include an event statistic and/or an historical statistic of the participant in the live-action sporting event. These statistics may be associated with a physical form of the participant in comparison with an ideal form maintained by the event control data, and/or with a trajectory of a projectile in comparison with an ideal trajectory maintained by the event control data.

The event module generating the live-action sport data may be part of the subscription-based location network, which could include a set of geographically dispersed capture locations each having the event module. The method may further include providing access through a portal on an Internet network, and determining the access privilege during a registration of a user on the portal such that various parties can access a portion of the live-action sport data and/or the meta-data based on an access privilege. The access privilege may be dynamically changed when an owner of the portion of the live-action sport data adjusts a parameter on the portal. The method may include placing a targeted advertisement on the portal based on the access privilege. The method may also include creating an archival history of performance of a participant based on aggregate data collected of the participant, and trending the archival history with current performance of the participant to generate a graphical representation of an evolution in a performance metric of the participant.

In another aspect, a method includes determining that an entrant is an authorized party based on an authentication with a subscription module of a subscription-based location network and capturing a performance data associated with the entrant during a live-action event at any capture location associated with the subscription-based location network. The method may further include processing a payment by the entrant based on a contractual obligation of the entrant with the subscription-based location network, and/or communicating an acknowledgement of the payment to an access module through a network.

In yet another aspect, the system includes a set of geographically dispersed capture locations of a subscription-based location network and an access module to aggregate live-action sport data of the set of geographically dispersed capture locations and/or to provide an access privilege to a party. An access privilege may be to a portion of the live-action sport data and a meta-data associated with the portion, and/or may be based on a permission derived from an association formed during a registration stage by the party on the subscription-based location network. The access privilege may also be granted based on a parameter adjusted by an owner of the portion of the live-event sport data, who may be a participant in a live-action sporting event, a guardian of the participant, a coach, a sponsor, and/or a scout.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1A is a system view of an event module of a capture location that communicates with an analysis module and at least one participant device, a coach device, and a guardian device, according to one embodiment.

FIG. 1B is an exploded view of the analysis module of FIG. 1A, according to one embodiment.

FIG. 2 is an exploded view of the event module of FIG. 1A having a participant identifier module, an object identifier module, a participant motion analyzer, a control module, and a projectile motion analyzer, according to one embodiment.

FIG. 3 is a table view of content referenced by the central database of FIG. 1B, according to one embodiment.

FIG. 4 is a user interface view of a participant module of the analysis module of FIG. 1B, according to one embodiment.

FIG. 5 is a user interface view of a guardian module of the analysis module of FIG. 1B, according to one embodiment.

FIG. 6 is a diagrammatic representation of a data processing system capable of processing a set of instructions to perform any one or more of the methodologies herein, according to one embodiment.

FIG. 7 is a user interface view of a coach module of the analysis module of FIG. 1B, according to one embodiment.

FIG. 8 is a user interface view of a sponsor module of the analysis module of FIG. 1B, according to one embodiment.

FIG. 9 is a process flow to generate a meta data based on an analysis of a live-action sport data with an event control data, according to one embodiment.

FIG. 10 is a process flow to determine that an entrant is an authorized party based on an authentication with a subscription module of a subscription-based location network, according to one embodiment.

Other features of the present embodiments will be apparent from the accompanying drawings and from the detailed description that follows.

### DETAILED DESCRIPTION

Segmentation and communication of live-action sporting event data apparatus and method is disclosed. In the following description, for the purposes of explanation, numerous specific details are set forth in order to provide a thorough understanding of the various embodiments. It will be evident, however to one skilled in the art that the various embodiments may be practiced without these specific details.

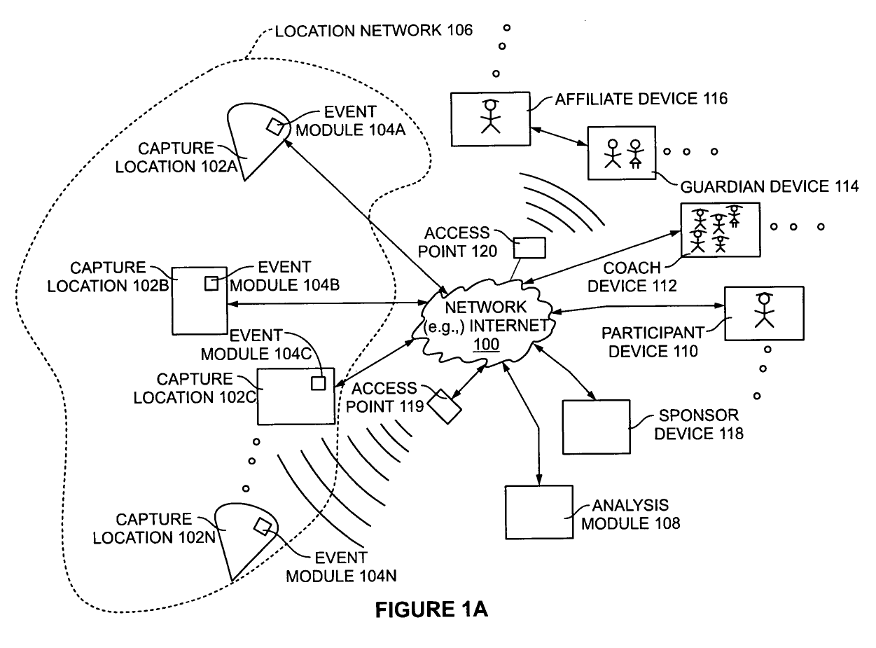

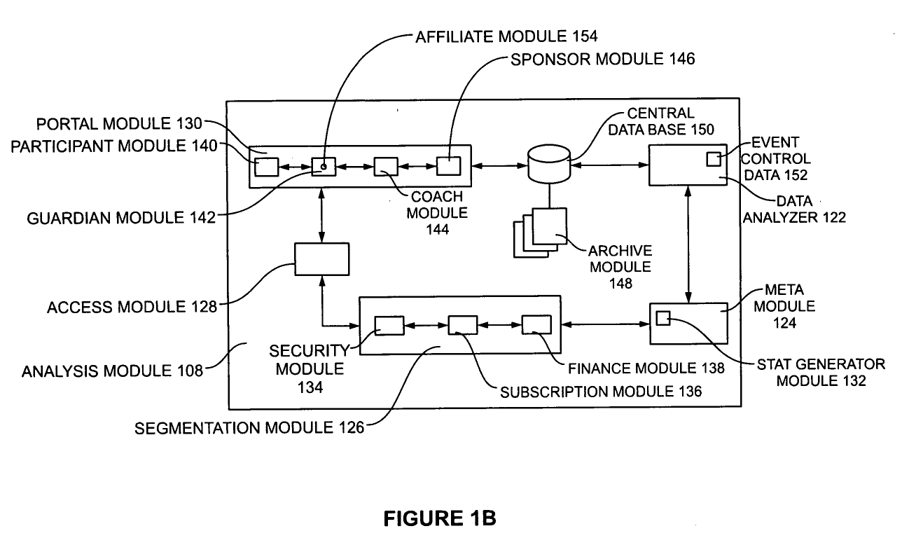

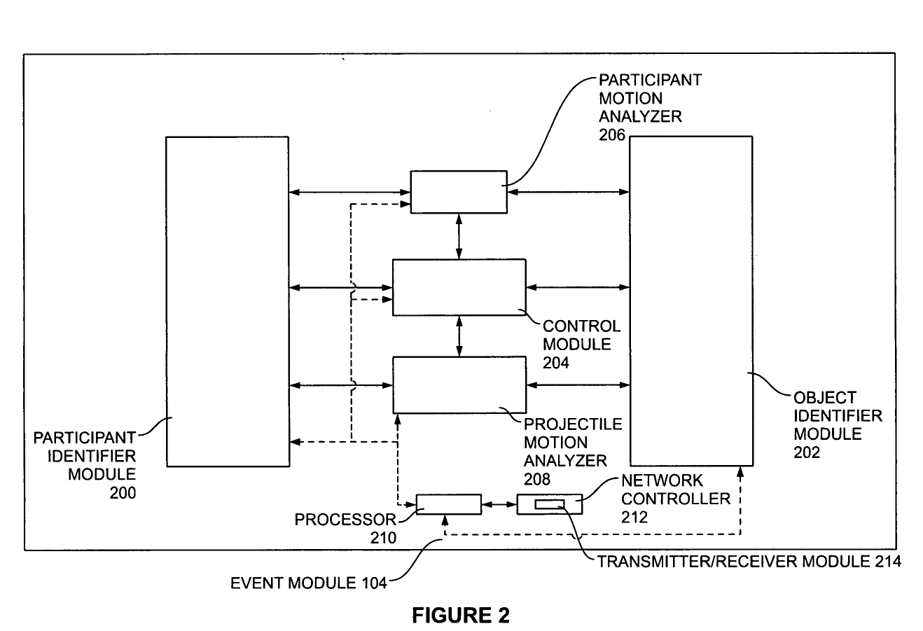

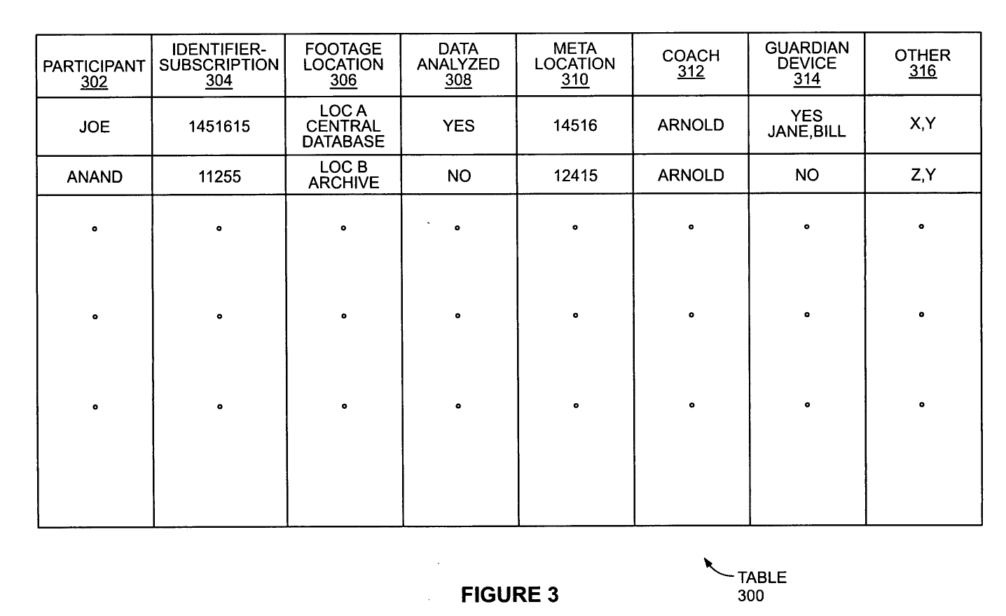

An example embodiment provides a method of generating a meta data (e.g., using a meta module 124 of FIG. 1A) based on an analysis (e.g., using a data analyzer 122 of FIG. 1B) of a live-action sport data (e.g., captured using event modules 104 of FIG. 1A) with an event control data (e.g., an event control data 152 of FIG. 1B), segmenting the live-action sport data (e.g., using a segmentation module 126 of FIG. 1B) based on an identifier code (e.g., an identifier-subscription 304 of FIG. 3) referenced by an event module (e.g., an event module 104 of FIG. 2) generating the live-action sport data, and providing access (e.g., using a portal module 130 of FIG. 1B) to the live-action sport data and the meta data based on an affiliation with a subscription-based location network (e.g., a location network 106 of FIG. 1A).

In another embodiment, a method may include determining that an entrant is an authorized party based on an authentication with a subscription module (e.g., a subscription module 136 of FIG. 1B) of a subscription-based location network (e.g., location network 106 of FIG. 1A) and capturing a performance data associated with the entrant (e.g., from a central database 150 of FIG. 1B) during a live-action event at any capture location (e.g., any of the capture locations 102 of FIG. 1A) associated with the subscription-based location network.

In yet another embodiment, a system may include a set of geographically dispersed capture locations (e.g., the capture locations 102A to 102N of FIG. 1A) of a subscription-based location network (e.g., a location network 106 of FIG. 1A), and an access module (e.g., an access module 128 of FIG. 1B) to aggregate live-action sport data (e.g., captured using event modules 104 of FIG. 2) of the set of geographically dispersed capture locations and to provide an access privilege to a party based on a permission derived from an association formed during a registration stage (e.g., using a subscription module 136 of FIG. 1B) by the party on the subscription-based location network. It will be appreciated that the various embodiments discussed herein may/may not be the same embodiment, and may be grouped into various other embodiments not explicitly disclosed herein.

FIG. 1A is a system view of an event module (e.g., an event module 104A) of a capture location (e.g., a capture location 102A) that communicates with an analysis module (e.g., an analysis module 108) and at least one participant device (e.g., a participant device 110), a coach device (e.g., a coach device 112), and a guardian device (e.g., a guardian device 114), according to one embodiment. In FIG. 1A, a location network 106 (e.g., a members-only group of stadiums and/or playing fields) may include any number of capture locations 102 (e.g., baseball stadiums, hockey stadiums, cricket stadiums, racket game courts, soccer stadiums, bowling alleys, ping pong tables, chess boards, shooting ranges, music orchestras, etc.). In one embodiment, a projectile is not used in play, but solely live-action player motion is captured (e.g., swimming, diving, and/or skiing, etc.) by the capture locations 102.

One or more participants, guardians, coaches, and/or interested parties may choose to provide consideration to the location network 106 in exchange for an opportunity to practice their skill in any of the capture locations 102. For example, a guardian (e.g., a parent) may purchase a monthly subscription (e.g., $50 per month) to the location network 106 so that their affiliate (e.g., their children) can access facilities in any of the capture locations 102.

The capture locations 102 may be geographically dispersed. For example, a capture location 102B may in St. Louis, Mo., while a capture location 102N may be in London, England. Furthermore, the capture locations 102 may be different types of sporting and/or recreational facilities. For example, a capture location 102A may be a baseball stadium, while the capture location 102B may be a tennis court, a sporting facility, an academy and/or a coaching center.

Each of the capture locations 102 may include event modules 104. The event modules 104 may be formed using specialized hardware, software, people, and/or infrastructure that aid in electronically documenting (e.g., video capture) live-action events, positions of players, and/or motions of projectiles used in play (e.g., during competitive sport and/or training). The event modules 104 may communicate with the analysis module 108, a participant device 110, a coach device 112, a guardian device 114, an affiliate device 116, and/or a sponsor device 118 through a network 100 as illustrated in FIG. 1A. Any of the event modules 102 may communicate wirelessly through an access point 119 and/or may be directly coupled with the network 100 as illustrated in FIG. 1A. Also, the participant device 110, the coach device 112, the guardian device 114, the affiliate device 116, and/or the sponsor device 118 may communicate wirelessly through an access point 120 and/or may be directly coupled with the network 100 as illustrated in FIG. 1A.

The analysis module 108 of FIG. 1A is best understood with reference to FIG. 1B. FIG. 1B is an exploded view of the analysis module 108 of FIG. 1A, according to one embodiment. The analysis module 108 of FIG. 1B includes a data analyzer 122, a meta module 124, a segmentation module 126, an access module 128, and/or a portal module 130. The data analyzer 122 may be used to process (e.g., determine rules, applicable limits, etc.) performance data (e.g., video data, live-action data, etc.) captured by the event modules 104 of the capture locations 102 of FIG. 1A according to one embodiment. The data analyzer 122 is illustrated as including an event control data 152. The event control data 152 may have information of ideal states for particular positions and/or motions of participants and/or projectiles used in a live-action sporting event occurring in the capture locations 102.

The data analyzer 122 may communicate with a meta-module 124. The meta-module 124 may be used to assign descriptive information (e.g., length of an inning, number of runs scored, color of uniform, physically defining characteristics of participants, etc.) to the performance data evaluated by the data analyzer 122. The meta-module 124 may include a stat-generator module 132 for determining statistical information (e.g., number of hits, number of strike outs, aggregate batting averages, etc.) about a particular set of performance data. In one embodiment, the meta-module 102 may include categorization information such as a level of play of a participant such as an amateur, a semi-pro level, a regional level, a state level, and a national level.

The meta-module 124 may communicate with a segmentation module 126. The segmentation module 126 may be used to categorize the performance data associated with participants in the live-action sporting event (e.g., based on the physical characteristics and/or identifiers). The segmentation module 126 is illustrated as including a security module 134, a subscription module 136, and/or a finance module 138. The security module 134 may be used to monitor integrity (e.g., prevent tampering) of the data managed (e.g., stored) in the analysis module 108, and/or to perform validation using encrypted algorithms (e.g., a 64 bit encrypted algorithm).

The subscription module 136 may be used to determine that a particular user (e.g., the participant, the coach, the guardian, etc.) of the analysis module 108 is registered on a database of subscribers (e.g., the database of subscribers may be stored in a central database 150 of FIG. 1B) of the location network 106 of FIG. 1A. The finance module 138 may be used in conjunction with the subscription module 136 to determine whether the particular user tendered and/or remitted a consideration (e.g., weekly, monthly, and/or annual subscription dues to the location network 106) in addition to being in the database of subscribers. In addition, the finance module 138 may be used to process payment (e.g., may be a confirmation screen to illustrate that the particular user and/or transaction is current) from the particular user for a subscription on the location network 106.

The segmentation module 126 may communicate with an access module 128. The access module 128 may be used to control access to a website embodying a portal module 130 as illustrated in FIG. 1B. A user may be allowed to set and/or modify parameters associated with access privilege using the portal module 130. The portal module 130 may allow the particular user to view, edit, and/or modify parameters associated (e.g., directly and/or indirectly) with performance data (e.g., statistical records, action video, and/or other meta data, etc.) of one or more parties (e.g., an individual, a coach, and/or a team) in the live-action event. The portal module 130 is illustrated in FIG. 1B as including a participant module 140, a guardian module 142, a coach module 144, and/or a sponsor module 146, according to one embodiment.

The participant module 140 may allow a participant (e.g., a player) to view personally and/or distally relevant performance data (e.g., current and/or historical statistics). The guardian module 142 may allow a guardian (e.g., a parent of a player) to view personally and/or distally relevant performance data (e.g., current and/or historical statistics) of their affiliate (e.g., their children and/or their wards). The guardian module 142 may include an affiliate module 154 that permits access directly to the affiliate (e.g., a child of the parent). The coach module 144 may allow a coach (e.g., a scout, a trainer, a manager) to view personally and/or distally relevant performance data (e.g., current and/or historical statistics) of their current, past, and/or prospective teams and/or players. The sponsor module 146 may allow a sponsor (e.g., an advertiser) to monitor a sponsorship portfolio (e.g., performance of certain players, teams, coaches, etc.).

Also illustrated in FIG. 1B are a central database 150 and an archive module 148. The central database 150 may be used as a dynamic repository of all performance data, meta data, and/or video data associated with any number of capture locations 102 in the location network 106 of FIG. 1A. In one embodiment, the central database 150 also stores data on user mappings (e.g., relationships between a players and/or teams, etc.). The archive module 148 may be used to back-up and/or store older (e.g., more than 6 months ago) performance data, meta data, and/or video data associated with one or more users.

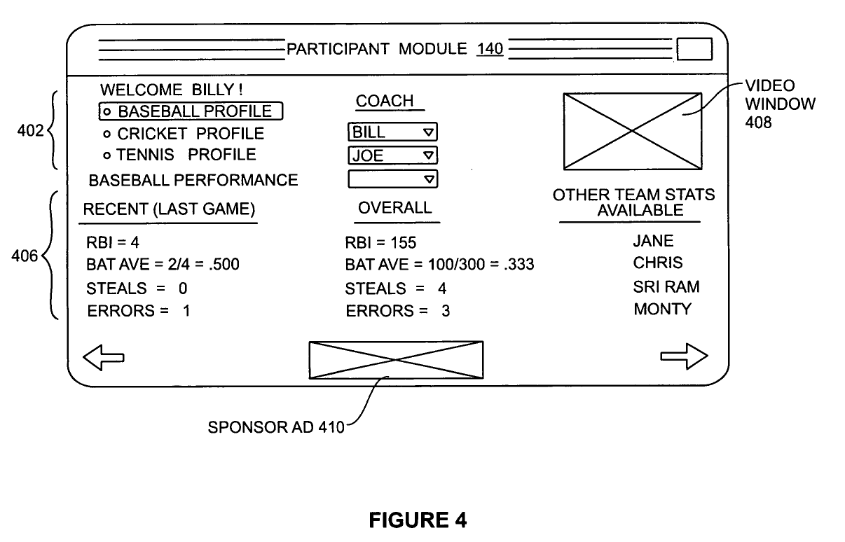

Referring back to FIG. 1A, the location network 106 and the analysis module 108 also communicate through the network 100 with a participant device 110, a team device 112, a guardian device 114, an affiliate device 116, and/or a sponsor device 122. The participant device 110 may be a data processing system used by a participant (e.g., a player and/or a coach) to access the participant module 140 of FIG. 1B. A user interface view of the participant module 140 accessed by the participant device 110 is illustrated in FIG. 4.

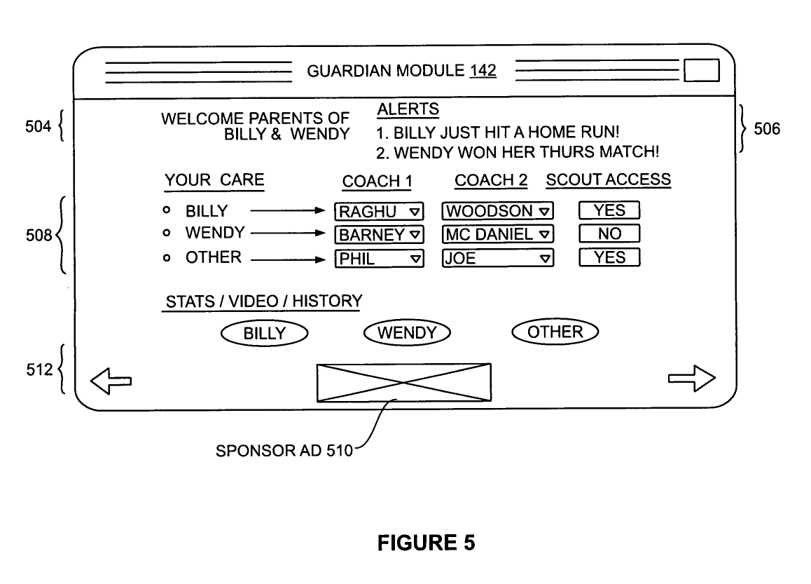

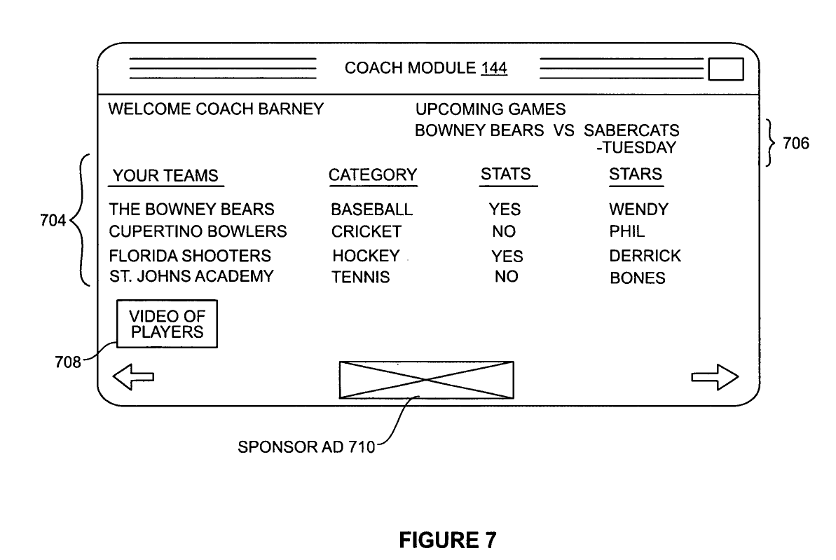

The coach device 112 may be a data processing system used by a team (e.g., an administrator) to access the coach module 144 of FIG. 1B. A user interface view of the coach module 144 used by the coach device 112 is illustrated in FIG. 7. The guardian device 114 may be a data processing system used by a guardian (e.g., a parent of the player) to access the guardian module 142 of FIG. 1B). A user interface view of the guardian module 142 used by the guardian device 114 is illustrated in FIG. 5. The affiliate device 116 may be a data processing system used by a participant (e.g., a child of the parent and/or an underage player) to access the affiliate module 154 of FIG. 1B).

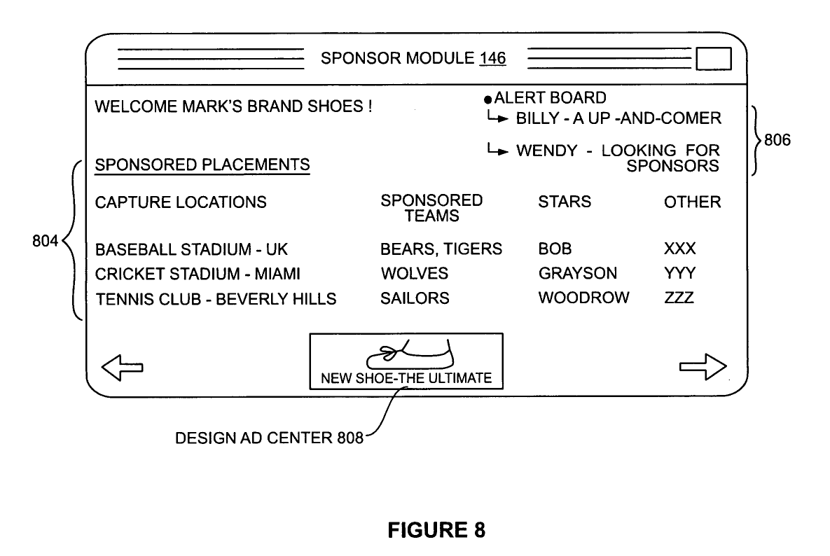

The sponsor device 118 may be a data processing system used by a participant (e.g., an advertiser) to access the sponsor module 146 of FIG. 1B). A user interface view of the sponsor module 146 used by the sponsor device 118 is illustrated in FIG. 8.

FIG. 2 is an exploded view of the event module 104 of FIG. 1A having a participant identifier module 200, an object identifier module 202, a participant motion analyzer 206, a control module 204, and a projectile motion analyzer 208, according to one embodiment. The participant identifier module 200 may use dynamic (e.g., live-action sporting data captured by an event module 104 of FIG. 1A) and/or static (e.g., from an event control data 152 of FIG. 1B) performance data associated with a participant to monitor (e.g., to identify, to track and/or to store, etc.) and/or to process (e.g., to interpret, to compare, to trend and/or to communicate, etc.) forms and/or attributes associated with participants in event action (e.g., jersey colors, characteristic motions, physical features, non-uniform accessories, etc.)

The object identifier module 202 may use dynamic (e.g., live-action sporting data captured by an event module 104 of FIG. 1A) and/or static (e.g., from an event control data 152 of FIG. 1B) performance data associated with an object (e.g., a baseball, a rugby ball, a tennis ball, a cricket ball, a shuttlecock, a projectile, ammunition and/or a board game piece etc.) to monitor (e.g., to identify, to track and/or to store, etc.) and/or to process (e.g., to interpret, to compare, to trend and/or to communicate, etc.) forms and/or attributes associated with an object in event action.

The participant motion analyzer 206 may be used to process motion data associated with the participants and/or affiliates (e.g., physical stance, kinematical efficiency, body position and/or axial extension, reaction time, and/or location relative to event location parameters etc.) In this embodiment, the participant motion analyzer 206 may communicate physical data, audio and/or visual feeds, motion capture and/or meta data with the participant identifier module 200.

The projectile motion analyzer 208 may be used to collect, record, track, and/or communicate data associated with a projectile and/or object in event action (e.g., ball color, pitch trajectory, projectile flight time, object acceleration, translational velocity, force generated at impact points, rotational spin, swing, distance traveled, absolute references and/or relative location references etc.) In this embodiment, the projectile motion analyzer 208 may communicate physical data, audio and/or visual feeds, motion capture and/or meta data with the object identifier module 202.

The control module 204 may be used to coordinate and/or communicate information (e.g., using performance data schemas, parameters and/or meta data for projectile motion, participant motion, participant identification and/or object identification) between the participant identifier module 200, the participant motion analyzer 206, the object identifier module 202, and/or the projectile motion analyzer 208.

The processor 210 may be used to process, to monitor, to regulate, to stabilize, to interpret, and/or to communicate data between the participant identifier module 200, the object identifier module 202, the projectile motion analyzer 208, the participant motion analyzer 206, and/or the control module 204. The processor 210 may also communicate with the network controller 212.

The network controller 212 may include a transmitter/receiver module 214. The network controller 212 may be used to process and/or monitor data communicated (e.g., with the analysis module 108 of FIG. 1B through the network 100 of FIG. 1A) through the transmitter/receiver module 214.

FIG. 3 is a table view of content referenced by the central database 150 of FIG. 1B, according to one embodiment. The table 300 in FIG. 3 may include a participant field 302, an identifier-subscription field 304, a footage location field 306, a data analyzed field 308, a meta location field 310, a coach field 312, a guardian device field 314, and an other field 316.

The participant field 302 may be a name and/or identification tag associated with a participant access privilege (e.g., monitored and/or communicated by the subscription module 136 of FIG. 1B). The identifier-subscription field 304 may be a unique identification and/or reference index associated with the participant (e.g., referenced from the subscription module 136 of FIG. 1B). The footage location field 306 may be a reference index indicating the location of video footage associated with the participant. (e.g., video footage located in a particular location of the central database 150 of FIG. 1B). The data analyzed field 308 may indicate a status and/or availability associated with the progress of video footage analysis (e.g., an affirmative value ‘Yes’ indicating the completion and/or availability of video footage associated with the participant). The meta location field 310 may indicate where meta data associated with the participant is located in the central database 150 of FIG. 1B.

The coach field 312 may indicate an identifier for any number of coaches associated with the participant (e.g., a coach entity in a profile view 402 established and/or modified by the participant in the participant module 140 of FIG. 4). The guardian device field 314 may indicate an enablement status and/or an identifier for any number of guardians associated with the participant (e.g., a guardian entity for the participant established and or modified by referencing associations made by the guardian in the affiliates field 508 of the guardian module of FIG. 5). The other field 316 may indicate miscellaneous and/or additional information associated with and/or relevant to the participant.

For example, two participants are illustrated in FIG. 3 (e.g., ‘Joe’ and ‘Anand’). The participant ‘Joe’ has an identifier—subscription field value ‘1451615’ indicating identification and/or a reference index associated with ‘Joe,’ a footage location ‘Loc A Central Database’ indicating that video footage associated with Joe is located in location A of the central database 150 of FIG. 1B, his data analyzed field is ‘Yes’ indicating his data has been analyzed by the data analyzer 122 of FIG. 1B, a meta location field 310 indicating where meta data associated with ‘Joe’ is located in the central database 150 of FIG. 1B, a coach field 312 indicating that coach ‘Arnold’ is associated with ‘Joe,’ and guardian device field 314 values ‘Yes’ and ‘Jane, Bill,’ indicating that ‘Joe’ has guardians ‘Jane’ and ‘Bill’ enabled. In addition, participant ‘Joe’ includes ‘X,Y’ in his other field 316, indicating any supplemental information that may be relevant to ‘Joe.’

The participant ‘Anand’ has an identifier—subscription field value ‘11255’ indicating identification and/or a reference index associated with ‘Anand,’ a footage location ‘Loc B Archive’ indicating that video footage associated with ‘Anand’ is located in location B of the archive 148 of FIG. 1B, his data analyzed field is ‘No’ indicating his data has not been analyzed by the data analyzer 122 of FIG. 1B, a meta location field 310 indicating where meta data associated with ‘Anand’ is located in the central database 150 of FIG. 1B, a coach field 312 indicating that coach ‘Arnold’ is associated with ‘Anand,’ and guardian device field 314 values ‘No’ indicating that ‘Anand’ does not have guardians enabled. In addition, participant ‘Anand’ includes ‘Z,Y’ in his other field 316, indicating any supplemental information that may be relevant to ‘Anand’.

FIG. 4 is a user interface view of a participant module 140 of the analysis module 108 of FIG. 1B, according to one embodiment. The user interface view may include a profile view 402, a video window 406, a performance view 408, and a sponsor ad 410. The profile view 402 may include a welcome message, a list of activity profiles associated with the participant (e.g., tennis, cricket, shooting, chess, etc.), and/or a coach view indicating any number of coaches associated with the participant.

The video window 406 may display video footage and/or visualizations of meta data associated with the participant (e.g., video footage associated with and/or relevant to the participant, from a footage location 306 of FIG. 3, referencing event action captured in a capture location 102 of FIG. 1A). The performance view 408 may include a current view, an aggregate view and/or team view. The current view may include various displays and/or visualizations of performance history and/or meta data associated with and/or relevant to the participant for a particular activity (e.g., selected from the profile view 402 of FIG. 4), and for a particular event (e.g., a match, a game, etc.) The aggregate view may include various displays and/or visualizations of performance history and/or meta data associated with and/or relevant to the participant for a particular activity (e.g., selected from the profile view 402 of FIG. 4), and for an aggregate event history (e.g., a match, a tournament, a season and/or all previous activity, etc.) The team view may display identifiers referencing performance histories and/or meta data associated with other participants affiliated with the participant (e.g., members of the same team as the participant). ‘Billy’ may also view the sponsor ad 410.

For example, a hypothetical participant ‘Billy’ is illustrated in FIG. 4. The user interface view includes a welcome message ‘Welcome Billy!’ identifying ‘Billy’ as a participant. The profile view 402 has ‘Baseball Profile,’ ‘Cricket Profile,’ and ‘Tennis Profile,’ indicating that ‘Billy’ is a participant in baseball, cricket and tennis activities. The coach view displays ‘Bill’ and ‘Joe,’ indicating that the coaches ‘Bill’ and ‘Joe’ are associated with the participant ‘Billy.’ The video window 408 may display video footage and/or visualizations of meta data associated with ‘Billy.’

In the performance view 406 ‘Baseball Performance,’ the current view ‘Recent (Last Game)’ displays ‘RBI=4,’ ‘Bat Ave= 2/4=0.5,’ ‘Steals=0,’ and ‘Errors=1,’ indicating a performance history and/or meta data associated with and/or relevant to ‘Billy’ for his most recent ‘Baseball’ game. The aggregate view ‘Overall’ displays ‘RBI =155,’ ‘Bat Ave= 100/300=0.333,’ ‘Steals=4’ and ‘Errors=3,’ indicating a performance history and/or meta data associated with and/or relevant to ‘Billy’ for his overall activity history. ‘Billy’ may also view the sponsor ad 410.

FIG. 5 is a user interface view of a guardian module 142 of the analysis module 108 of FIG. 1B, according to one embodiment. The user interface view may include a welcome view 504, an alerts view 506, a user interface view of an affiliate module 154 of FIG. 1B, an affiliates view 508, and/or a performance view 512. The welcome view 504 may display a welcome message for the guardian entity (e.g., parents of a particular participant and/or affiliate). The alerts view 506 may include information related to performance highlights, event outcomes and/or messages of importance relevant to the guardian entity (e.g., an alert notifying the guardian of an event victory for a participant and/or team associated with the guardian).

The affiliates view 508 may include a list of affiliates associated with the guardian (e.g., children, relatives and/or wards of the guardian), a coach view that may display identifiers referencing any number of designated coaches for affiliates associated with the guardian, and/or a scout view that may display a status indicating permission levels for scouts to access performance histories and/or meta data for each of the affiliates associated with the guardian. The sponsor ad 510 may include an advertisement and/or marketing related display associated with a sponsor (e.g., an ad design created and/or modified by the sponsor in design ad center 808 of FIG. 8). The performance view 512 may include links to displays of performance history, video footage and/or meta data for each of the affiliates associated with the guardian.

For example, a hypothetical guardian ‘Parents of Billy & Wendy’ is illustrated in FIG. 5. The user interface view includes a welcome message ‘Welcome Parents of Billy & Wendy!’ identifying the parents of ‘Billy’ & ‘Wendy’ as a guardian entity. The affiliates view ‘Your Care’ displays identifiers ‘Billy,’ ‘Wendy,’ and ‘Other,’ indicating the affiliates associated with the ‘Parents of Billy & Wendy.’ In the affiliates view 508, the coach view ‘Coach 1’ displays identifiers ‘Raghu,’ ‘Barney’ and ‘Phil.’ The coach view ‘Coach 2’ has identifiers ‘Woodson,’ ‘McDaniel,’ and ‘Joe.’ The coach views indicate that affiliate ‘Billy’ is associated with coach ‘Raghu’ and coach ‘Woodson,’ affiliate ‘Wendy’ is associated with coach ‘Barney’ and coach ‘McDaniel,’ and affiliate ‘Other’ is associated with coach ‘Phil’ and coach ‘Joe.’

The scouts view displays values ‘Yes,’ ‘No,’ and ‘Yes,’ indicating that performance histories and/or meta data associated with affiliate ‘Billy’ is accessible to scouts, performance histories and/or meta data associated with affiliate ‘Wendy’ is not accessible to scouts, and performance histories and/or meta data associated with affiliate ‘Other’ is accessible to scouts. The alerts view 506 displays ‘1. Billy Just Hit a Home Run’ and ‘2. Wendy Won Her Thursday Match!’ indicating information related to affiliate performance highlights, event outcomes and/or messages of importance relevant to the ‘Parents of Billy & Wendy.’ The performance view 512 includes links to displays of performance history, video footage and/or meta data for each of the affiliates ‘Billy,’ ‘Wendy’ and ‘Other’ associated with the ‘Parents of Billy & Wendy.’ The ‘Parents of Billy & Wendy’ may also view the sponsor ad 510.

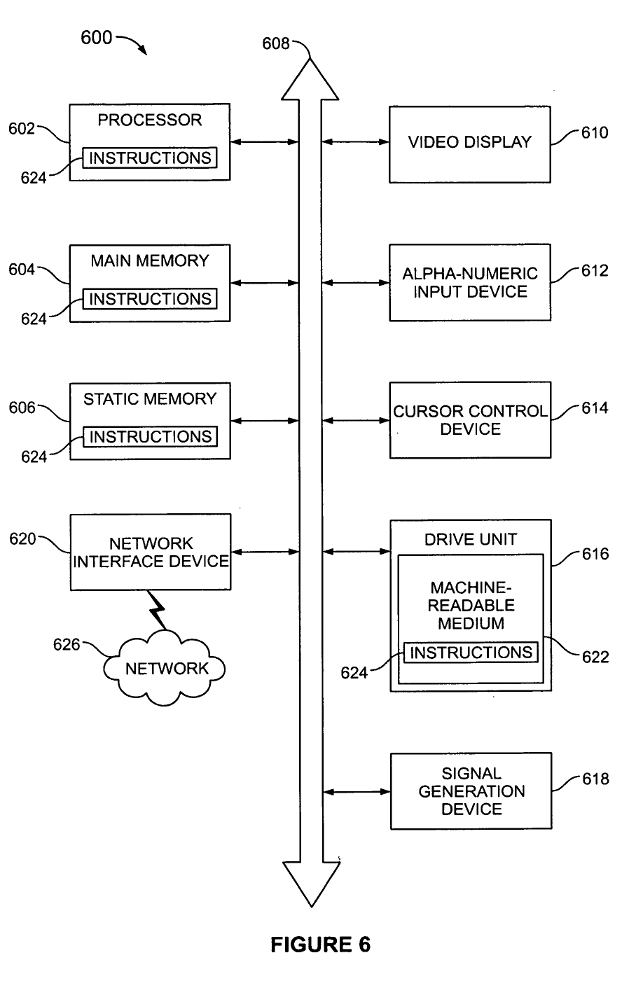

FIG. 6 shows a diagrammatic representation of machine in the example form of a computer system 600 within which a set of instructions, for causing the machine to perform any one or more of the methodologies discussed herein, may be executed. In various embodiments, the machine operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 600 includes a processor 602 (e.g., a central processing unit (CPU) a graphics processing unit (GPU) and/or both), a main memory 604 and a static memory 606, which communicate with each other via a bus 608. The computer system 600 may further include a video display unit 610 (e.g., a liquid crystal display (LCD) and/or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions (e.g., software 624) embodying any one or more of the methodologies and/or functions described herein. The software 624 may also reside, completely and/or at least partially, within the main memory 604 and/or within the processor 602 during execution thereof by the computer system 600, the main memory 604 and the processor 602 also constituting machine-readable media.

The software 624 may further be transmitted and/or received over a network 626 via the network interface device 620. While the machine-readable medium 622 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

FIG. 7 is a user interface view of a coach module 144 of the analysis module 108 of FIG. 1B, according to one embodiment. The user interface view may include a welcome message, a profile view 704, a schedule view 706, a video view 708 and/or a sponsor ad 710. The profile view 704 may include a portfolio view that may display identifiers for any number of teams associated with the coach, a category view that may display category identifiers for each of the teams associated with the coach, a statistics view that may indicate a status for the availability of performance histories, video footage, and/or meta data for each of the teams in the portfolio view, and/or a stars view that may display identifiers referencing participants with superior performances, according to any combination of criteria, for each of the teams in the portfolio view.

The video view 708 may include displays of video footage and/or visualizations of meta data for event performances of participants associated with the coach (e.g., video footage associated with and/or relevant to the participant, from a footage location 306 of FIG. 3, referencing event action captured in a capture location 102 of FIG. 1A). The sponsor ad 710 may include an advertisement and/or marketing related display associated with a sponsor (e.g., an ad design created and/or modified by the sponsor in design ad center 808 of FIG. 8).

For example, a hypothetical ‘Coach Barney’ is illustrated in FIG. 7. The user interface view includes a welcome message identifying ‘Coach Barney.’ In the profile view 704, the portfolio view has ‘The Bowney Bears,’ ‘Cupertino Bowlers,’ ‘Florida Shooters,’ and ‘St. John's Academy,’ indicating teams associated with coach ‘Barney.’ The category view for ‘Coach Barney’ has ‘Baseball, ‘Cricket,’ ‘Hockey,’ and ‘Tennis,’ indicating that ‘The Bowney Bears’ is a team belonging to the category ‘Baseball,’ ‘Cupertino Bowlers’ is a team belonging to the category ‘Cricket,’ ‘Florida Shooters’ is a team belonging to the category ‘Hockey,’ and ‘St. John's Academy’ is a team belonging to the category ‘Tennis.’ The ‘Statistics’ view for ‘Coach Barney’ lists ‘Yes,’ ‘No,’ Yes,’ and ‘No,’ indicating that performance history, video footage, and/or meta data is available for ‘The Bowney Bears,’ unavailable for ‘Cupertino Bowlers,’ available for ‘Florida Shooters,’ and unavailable for ‘St. John's Academy.’

The stars view for ‘Coach Barney’ lists ‘Wendy,’ ‘Phil,’ ‘Derrick,’ and ‘Bones,’ indicating that the best performing participant for each team was ‘Wendy’ for ‘The Bowney Bears,’ ‘Phil’ for ‘Cupertino Bowlers,’ ‘Derrick’ for ‘Florida Shooters,’ and ‘Bones’ for ‘St. John's Academy.’ The schedule view 706 for ‘Coach Barney’ indicates his ‘Upcoming Games’ as ‘Bowney Bears vs. Sabercats—Tuesday.’ ‘Coach Barney’ may access the video view 708 to view video footage and/or performance visualizations of event actions for participants on any of the teams associated with ‘Barney.’ ‘Coach Barney’ may also view the sponsor ad 710.

FIG. 8 is a user interface view of a sponsor module 146 of the analysis module 108 of FIG. 1B, according to one embodiment. The user interface view may include a welcome message, a portfolio view 804, an alerts view 806, and/or a design ad center 808. The portfolio view 804 may include a location view, a sponsored teams view, a stars view and/or an other view. The location view may display identifiers for a capture location (e.g., a capture location 102 of FIG. 1A) identifying the location associated with a sponsored entity. The sponsored teams view may display identifiers referencing any number of teams associated with the sponsor. The stars view may display identifiers referencing the best-performing participants of each team in the sponsored teams view. The other field may include miscellaneous and/or additional information associated with each team and of relevance to the sponsor.

The alerts view 806 may include information related to performance highlights, event outcomes and/or messages of importance relevant to the sponsor (e.g., an alert notifying the sponsor that a participant and/or team is looking for sponsors). The design ad center 808 may include utilities, methods and/or processes for the sponsor to create, modify and/or distribute an advertisement and/or marketing related display (e.g., a sponsor ad generated in the user interface view of the participant module 140 of FIG. 4, the guardian module 142 of FIG. 5, and/or the coach module 144 of FIG. 7).

For example, a hypothetical sponsor ‘Mark's Brand Shoes’ is illustrated in FIG. 8. The user interface view includes a welcome message ‘Welcome Mark's Brand Shoes!’ identifying ‘Mark's Brand Shoes’ as the sponsor. In the portfolio view 804 ‘Sponsored Placements,’ the location view ‘Capture Locations’ has ‘Baseball Stadium—UK,’ ‘Cricket Stadium—Miami,’ and ‘Tennis Club—Beverly Hills,’ indicating sponsorship locations associated with ‘Mark's Brand Shoes.’ The ‘Sponsored Teams’ view has ‘Bears, Tigers,’ ‘Wolves’ and ‘Sailors,’ indicating that ‘Mark's Brand Shoes’ sponsors the teams ‘Bears’ and the team ‘Tigers,’ both associated with the capture location ‘Baseball Stadium—UK,’ the team ‘Wolves,’ associated with the capture location ‘Cricket Stadium—Miami,’ and the team ‘Sailors,’ associated with the capture location ‘Tennis Club—Beverly Hills.’

The stars view has ‘Bob,’ ‘Grayson’ and ‘Woodrow,’ indicating that for the teams sponsored by Mark's Brand Shoes, ‘Bob’ was the best-performing participant in the ‘Bears’ team and the ‘Tigers’ team, ‘Grayson’ was the best-performing participant in the ‘Wolves’ team, and ‘Woodrow’ was the best-performing participant in the ‘Sailors’ team. The alerts view ‘Alert Board’ displays ‘Billy—An Up-And-Comer,’ and ‘Wendy—Looking For Sponsors,’ indicating information related to performance highlights, event outcomes and/or messages of importance relevant to ‘Mark's Brand Shoes.’ The design ad center 808 displays ‘New Shoe—The Ultimate,’ indicating a particular advertisement and/or marketing related display created, modified and/or distributed by ‘Mark's Brand Shoes.’

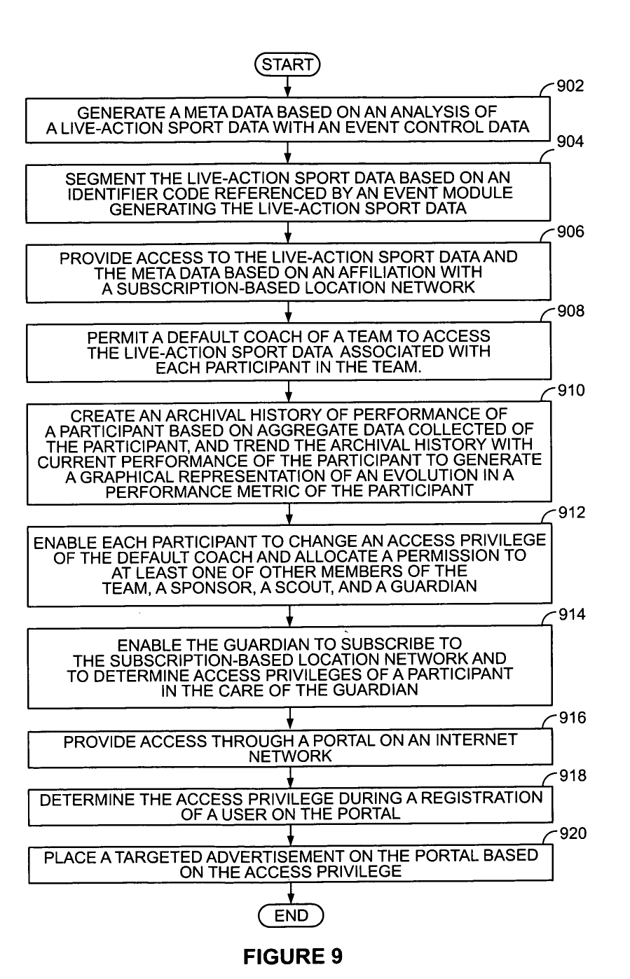

FIG. 9 is a process flow to generate a meta data based on an analysis of a live-action sport data with an event control data, according to one embodiment. In operation 902, meta data may be generated (e.g., by the meta module 124 of FIG. 1B) based on an analysis of a live-action sport data with an event control data. In operation 904, the live-action sport data may be segmented based on an identifier code referenced by an event module generating the live-action sport data. In operation 906, access may be provided to the live-action sport data and/or the meta data based on an affiliation with a subscription-based location network.

In operation 908, a default coach of a team may be permitted access to the live-action sport data associated with each participant in the team. In operation 910, an archival history of performance of a participant may be created based on aggregate data collected of the participant, and the archival history may be trended with current performance of the participant to generate a graphical representation of an evolution in a performance metric of the participant. In operation 912, each participant may be enabled to change an access of the default coach and allocate a permission to at least one of other members of the team, a sponsor, a scout, and a guardian. In operation 914, the guardian may be enabled to subscribe to the subscription-based location network and to determine access privileges of a participant in the care of the guardian. In operation 916, access may be provided through a portal on an internet network. In operation 918, an access privilege may be determined during a registration of a user on the portal. In operation 920, a targeted advertisement may be placed on the portal based on the access privilege.

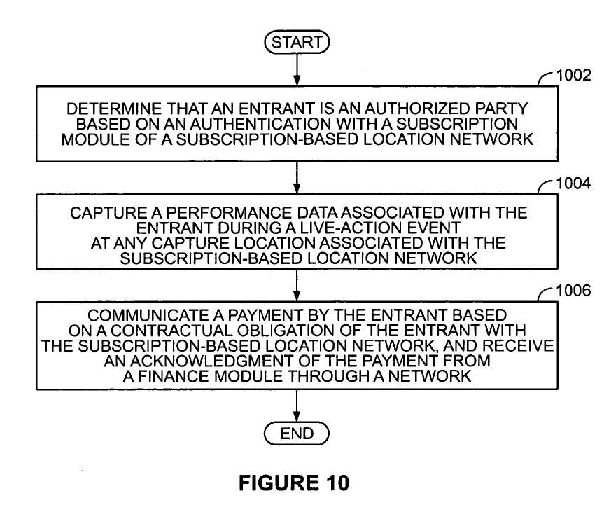

FIG. 10 is a process flow to determine that an entrant is an authorized party based on an authentication with a subscription module of a subscription-based location network, according to one embodiment. In operation 1002, and entrant may be determined as an authorized party based on an authentication with a subscription module of a subscription-based location network. In operation 1004, a performance data associated with the entrant may be captured during a live-action event at any capture location associated with the subscription-based location network. In operation 1006, a payment may be communicated by the entrant based on a contractual obligation of the entrant with the subscription-based location network, and an acknowledgement of the payment may be received from a finance module through a network.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the event module 104, the analysis module 108, the data analyzer 122, the meta module 124, the stat generator module 132, the segmentation module 126, the security module 134, the subscription module 136, the finance module 138, the access module 128 the portal module 130, the participant module 140, the guardian module 142, the affiliate module 154, the coach module 144, the sponsor module 146, the archive module 148, the participant identifier module 200, the participant motion analyzer 206, the object identifier module 202, the projectile motion analyzer 208, the control module 204, the processor 210, the network controller 212, and/or the transmitter/receiver module 214 may be enabled using an event circuit, an analysis circuit, a data analyzer circuit, a meta circuit, a stat generator circuit, a segmentation circuit, a security circuit, a subscription circuit, a finance circuit, an access circuit, a portal circuit, a participant circuit, a guardian circuit, an affiliate circuit, a coach circuit, a sponsor circuit, an archive circuit 148, a participant identifier circuit, a participant motion analyzer, an object identifier circuit, a projectile motion analyzer circuit, a control circuit 204, a processor circuit, a network controller circuit, and/or a transmitter/receiver circuit using transistors, logic gates, and electrical circuits (e.g., application specific integrated ASIC circuitry) using a server circuit, a client circuit, a content circuit, a data analyzer circuit, a rules circuit, a configuration circuit, a simultaneous display circuit, a configuration requestor circuit, a relationship circuit, a nesting generator circuit, a configurator circuit, a reverse configurator circuit, a identification generator circuit, and/or a model generator circuit.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarder in an illustrative rather than a restrictive sense.

What is claimed is:

1. A method comprising:
generating a meta data based on an analysis of a live-action sport data with an event control data;
segmenting the live-action sport data based on an identifier code referenced by an event module generating the live-action sport data; and
providing access to the live-action sport data and the meta data based on an affiliation with a subscription-based location network.

2. The method of claim 1 further comprising permitting a default coach of a team to access the live-action sport data associated with each participant in the team.

3. The method of claim 2 further comprising enabling each participant to change an access privilege of the default coach and to allocate a permission to at least one of other members of the team, a sponsor, a scout, and a guardian.

4. The method of claim 3 further comprising enabling the guardian to subscribe to the subscription-based location network and to determine access privileges of a participant in the care of the guardian.

5. The method of claim 1 wherein the event control data includes a parametric model of an ideal state of at least one of a particular form of a participant and a trajectory of a projectile utilized in a live-action sporting event associated with the live-action sport data.

6. The method of claim 5 wherein the meta-data includes at least one event statistic and at least one historical statistic of the participant in the live-action sporting event.

7. The method of claim 6 wherein the at least one event statistic and the at least one historical statistic is associated with a physical form of the participant in comparison with an ideal form maintained by the event control data.

8. The method of claim 6 wherein the at least one event statistic and the at least one historical statistic is associated with a trajectory of a projectile in comparison with an ideal trajectory maintained by the event control data.

9. The method of claim 1 wherein the event module generating the live-action sport data is part of the subscription-based location network, and wherein the subscription-based location network includes a set of geographically dispersed capture locations each having the event module.

10. The method of claim 9 further comprising providing access through a portal on an Internet network, and wherein various parties access a portion of the live-action sport data and the meta-data based on an access privilege.

11. The method of claim 10 further comprising determining the access privilege during a registration of a user on the portal and wherein the access privilege may be dynamically changed when an owner of the portion of the live-action sport data adjusts a parameter on the portal.

12. The method of claim 11 further comprising placing a targeted advertisement on the portal based on the access privilege.

13. The method of claim 1 further comprising creating an archival history of performance of a participant based on aggregate data collected of the participant; and trending the archival history with current performance of the participant to generate a graphical representation of an evolution in a performance metric of the participant.

14. A method comprising:
determining that an entrant is an authorized party based on an authentication with a subscription module of a subscription-based location network; and
capturing a performance data associated with the entrant during a live-action event at any capture location associated with the subscription-based location network.

15. The method of claim 14 further comprising communicating a payment by the entrant based on a contractual obligation of the entrant with the subscription-based location network; and receiving an acknowledgement of the payment from a finance module through a network.

16. The method of claim 14 in a form of a machine-readable medium embodying a set of instructions that, when executed by a machine, cause the machine to perform the method of claim 14.

17. A system comprising:
a set of geographically dispersed capture locations of a subscription-based location network; and
an access module to aggregate live-action sport data of the set of geographically dispersed capture locations and to provide an access privilege to a party based on a permission derived from an association formed during a registration stage by the party on the subscription-based location network.

18. The system of claim 17 wherein the access privilege is to a portion of the live-action sport data and a meta-data associated with the portion.

19. The system of claim 18 wherein the access privilege is also granted based on a parameter adjusted by an owner of the portion of the live-event sport data.

20. The system of claim 19 wherein the owner is at least one of a participant in a live-action sporting event, a guardian of the participant, a coach, a sponsor, a scout, a virtual coach, a governing body, a biomechanics expert, a celebrity, and a statistician.
